(19) United States
(12) Patent Application Publication
(10) Pub. No.: US 2010/0102084 A1
(43) Pub. Date: Apr. 29, 2010

(54) Remote control cover

(76) Inventor: Suzanne W. Clark, Simpsonville, SC (US)

Correspondence Address: Suzanne W. Clark, 17 Mercer Drive, Simpsonville, SC, 29681, US

(21) Appl. No.: 12/655,268

(22) Filed: Dec. 28, 2009

Related U.S. Application Data
(63) Continuation-in-part of application No. 11/564,545, filed on Nov. 29, 2006.

(51) Int. Cl. B67D 7/06; B65D 85/00

(52) U.S. Cl. 222/80; 206/320; 222/173; 222/192

(57) ABSTRACT

A disposable cover for use with a remote control device is constructed having a transparent window in the top panel. The pouch-like cover relates to the shape of the remote control device it is covering. The flexible, moisture-resistant disposable cover prevents pathogens or contaminants on the surface of the remote control to contact the hand holding the control. The refillable dispensing container and reusable dispensing apparatus provide efficient hygienic delivery of individual covers using minimal packaging and space.

This application is a continuation-in-part of U.S. application Ser. No. 11/564,545 filed Nov. 29, 2006, now abandoned.

### BACKGROUND OF THE INVENTION

This invention relates to disposable covers placed on handheld remote control devices serving as barriers to microbes and other environmental contaminants. The flexible and transparent pouch-like covers are comprised of biodegradable materials and are inexpensive to manufacture.

It is well known that door knobs, keyboards, pens, television remote controls and any object used by the hotel guest may contain millions of germs. Pathogens thrive on smooth or moist surfaces and viruses may survive more than four days. Upon entering the hotel room a client may contact the doorknob once or twice, while handling the television remote control offers repeated opportunities for transmission of germs during the hotel stay. As global travel increases, new strains of viruses and pathogens may be imported or exported from one country to another via humans.

In hospital rooms, pathogens on objects contacted by the patient may become agents of infection. If a patient in a weakened condition due to illness or postsurgical recovery, exposure to additional microbes may introduce a secondary infection with significant implications. Pathogens present more serious consequences and may result in the premature death of a patient. A patient may enter a hospital for a routine or elective surgery, but end up gravely ill due to contact with a pathogen contacted in the hospital room.

Surfaces having a higher population of pathogens include remote or handheld controls for television, bed adjustment, patient controlled analgesia, and sleep apnea controls. By using a disposable cover, contamination risk may be reduced or eliminated. Historically, cleansers or spray cleaners were used to kill bacteria on handheld remote controls. They consist of sprays in a canister as shown in the patent by Veltman et al, U.S. Pat. No. 6,969,698, or cloths with solution on them. Spraying a remote control daily will compromise electronic function as cleaning agents seep into controls through the gaps around the control buttons. The hospitality or hotel cleaning crew easily overlooks the task of daily cleaning the remote control. Furthermore, there is no way to prove the controls have been sanitized.

Early prior art in this field reveals the patenting of remote control and handset covers for the purpose of protecting the electronic components from shock damage, liquids or other environmental contaminants Examples of patents associated with physical protective enclosures for an electronic device or handset are numerous. U.S. Pat. Nos. 4,836,256; 4,762,227; 5,388,691; 5,316,141; 6,471,056; 5,092,459 and 5,499,713 represent prior art in which protective qualities of the cover are described, including case-like features and foam-lined structures.

Prior art also emphasizes the “barrier” or “shield” like qualities of the cover. Contaminants comprising human biological waste, pathogens in the environment, or other infectious agents are prevented from crossing the bather provided by the cover from the control device to the hand holding the control device. Since the primary scope of the present invention is to prevent human exposure from contaminants, a closer look at the attributes of the present invention will reveal improvements and qualities not previously described in the art including a unique means of delivery and materials which are ecologically compatible.

While reviewing prior art which teach the protective qualities of the covers, the Hodges U.S. Pat. No. 7,290,654 presents a seamless molded unitary barrier which is impregnated with an anti-bacterial compound. In comparing the present invention with that of Hodges, the present invention does not require molds to be fabricated or the use of injection molding equipment, which results in lower start-up manufacturing costs.

The Clark et al U.S. Pat. No. 7,011,213 relates a “protective shield for a patient control device” which is a disposable shield to sheath a patient control device, in which there is a sealing clamp placed around the shield and cable to the nurse call device. The paper backing is used to stabilize the shield during the insertion of the nurse call device. The present invention employs a simple manufacturing process and likely less cost in materials when compared to the protective shield and clamp described by Clark et al. in U.S. Pat. No. 7,011,213. There is also less waste in the present invention as the covers do not require individual packaging.

Similarly, the Gammons U.S. Pat. No. 7,147,105 describes a sheath with a scalloped shoulder area which permits expansibility to accommodate controls with rotary dials, and is fabricated on a paper carrier, with one sheath mounted on each carrier within a storage package. Compared to the present invention, it is likely to be more expensive in the manufacturing process and is designed for a specific shape of remote control. The carrier papers are required for the Gammons patent but not in the present invention.

The Trujillo U.S. Pat. No. 6,050,407 exhibits a protective “sheath” which wraps snugly around the remote control, and is self-adhered. The additional open end does not provide as much coverage when compared to the present invention.

A variation is an “envelope” utilizing “gripper pads” which are of durable and reliable construction as described by the Huffer U.S. Pat. No. 5,499,713. The present invention has a simpler construction and does not utilize gripper pads.

The Goldberg U.S. Pat. No. 6,817,470 relates a flexible envelope with an application portion, a living hinge and an adhesive on the inner periphery of the sleeve. The present invention discloses a simpler construction, without the need for a flexible sleeve or sealing the cover.

Besides providing a barrier to inhibit the transfer of microorganisms, a second feature of the present invention includes a method of dispensing which uses minimal space on the hospital or hotel cleaning carts and at the same time facilitates hygienic delivery for each cover. Because the sanitary covers are dispensed by the housekeeping personnel, having a dispensing system attached to or placed on the cart ensures that each housekeeper will have convenient access to the sanitary covers, without needing to remove a backing or packaging or disposing of additional waste.

There is a need in the art to provide a simple disposable cover which is a secure protective barrier that adequately protects humans against contaminants and at the same time, uses a minimal percentage of synthetic composition in the covering structure. There is also a need for a method of use which utilizes a refillable container with a dispensing apparatus comprised of biodegradable materials, and provides hygienic delivery for each cover in an efficient and cost-effective manner.

### SUMMARY OF THE INVENTION

The present invention utilizes a simple manufacturing process which joins rectangular top and bottom panels on the outer edges of three sides. As there is no requirement for individual packaging, storing in a reusable container and dispensing from a reusable dispensing apparatus is the preferred method of use. The preferred embodiment for this invention and its dispensing apparatus comprises biodegradable material. With our landfills overflowing with non-degrading materials, another object of the present invention is to provide a flexible, durable and transparent cover manufactured from biodegradable material.

A biodegradable material is one which decomposes in a relatively short time to nontoxic water soluble materials. Light, air, microorganisms and moisture determine the rate of degradation. Using natural raw materials such as starch, cellulose or polylactic acid in the manufacturing of the flexible transparent cover is the preferred embodiment of the present invention, including the dispensing apparatus and container. Although a material containing synthetic polymer is extremely durable, providing durability beyond a single use is not a requirement of the present invention. Therefore, it is desirable and an object of the present invention to incorporate a degradable or compostable material with minimal synthetic component. The biodegradable component may range from 1% to 100% of the whole, with or without the use of additives including, but not limited to mineral fillers, plasticizers, and pigments to improve the thermoplastic properties of the material. Because durability is not the primary attribute of the present invention, the biodegradable component could be increased to maximum limits. Biodegradable compositions such as starch may be modified chemically by the process of cross linking, substitution, or combining with polymers to modify properties of the material. These properties include flexibility, elasticity, durability and moisture-resistance. Other materials, which may be used for the present invention in addition to the preferred embodiment which teaches biodegradable materials, are thermoplastics and paper.

Another object of the present invention is to provide a flexible, durable, moisture-resistant and transparent cover which is housed within a refillable container in which one panel contains a reusable dispensing apparatus, thereby minimizing materials. Although numerous remote control covers have been described in the art, there is a need to provide a cover which may be dispensed hygienically without the need for additional carrier papers and other costly materials. The method described in this innovative art addresses this issue in a way to maximize efficiency, space, and materials while minimizing material waste and the need to dispose of packaging on a daily basis.

Perhaps one of the most important features of the sanitary cover is that it provides users empowerment to avoid potentially contaminating agents. Another object of the present invention is to economically produce a disposable cover used extensively throughout the hotel and hospital supply industry as well as the general population.

It is also the object of this invention to provide a simple sanitary cover which relates in general to the size of the device it is covering. As a result, the variation in sizes of the remote control is accommodated while using fewer basic patterns.

For personal use, the remote control covers may be fastened at one end, and packaged in booklets. Each remote control cover may be removed from the booklet by tearing the perforation. For commercial use, primarily in the hospitality industry and hospitals, single remote control covers manufactured are connected end-to-end in a roll and placed within the dispensing unit. A perforation between single covers enables them to be dispensed one at a time, as they are unrolled and pass through the dispensing apparatus. In an alternative embodiment, covers may be manufactured individually without the need for a perforation.

### BRIEF DESCRIPTION OF THE DRAWINGS

FIG. 1 is a perspective view of the cover with the remote control inside.

FIG. 2 is a plan view of the components of the cover.

FIG. 3 is a perspective view of the booklet of remote control covers.

FIG. 4 is a top view of a hospital remote control device within the cover.

FIG. 5 is a side view of the cart and a blown-up view of its dispensing unit.

FIG. 6 is a front view of the dispensing unit.

FIG. 7 is a blown-up view of the slit opening in the dispensing unit.

FIG. 8 is a side-view of an alternative dispensing unit.

### DESCRIPTION OF THE SPECIFIC EMBODIMENTS

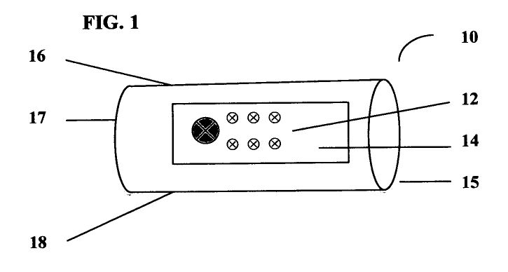

FIG. 1 is a perspective view of the cover 10 with the remote control 12 inside. The window area 14 permits viewing the channel or control buttons. When the control is placed in the cover through the open end 15, it is secured by closure at the opposite end 17 as well as the edges of the adjoined panels 16 and 18. The preferred method of joining the panels is by bonding, either ultrasonic or heat welding. However, adhesives may be applied for bonding the edges together.

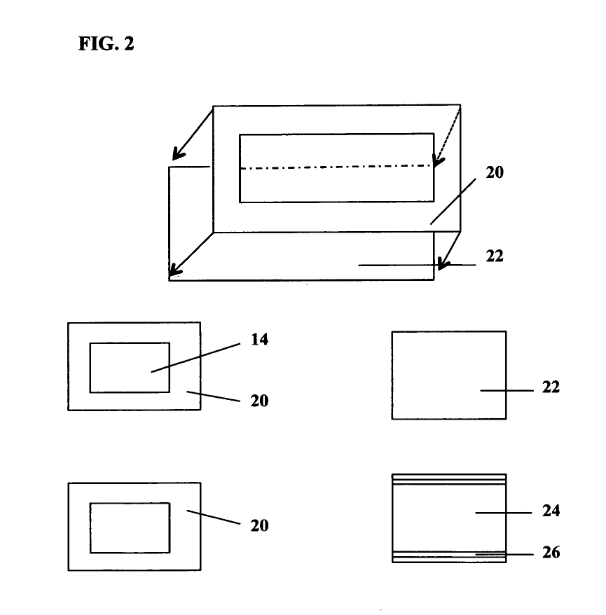

FIG. 2 shows the top panel, 20 the bottom panel 22 and how they are joined through heat welding, ultrasonic bonding, or through adhesives. The panels are joined on the edges of three sides, with one side remaining open for insertion of the control into the pouch-like structure. By enclosing the control on three sides, more protection from pathogens is realized as well as increased stability for the remote control. A variation shows a bottom panel 24 which is gusseted 26, to allow for larger sized remote controls. In general, the top and bottom panels relate to the size of the remote control they are covering. The top panel reveals a window area 14 which is transparent film. The transparent quality of the film is for viewing the control buttons through the top panel.

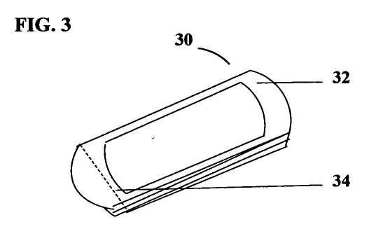

FIG. 3 depicts a booklet 30 of covers showing the perforation 34 where they may be detached for individual use. The open end 32 facilitates insertion of the remote control device.

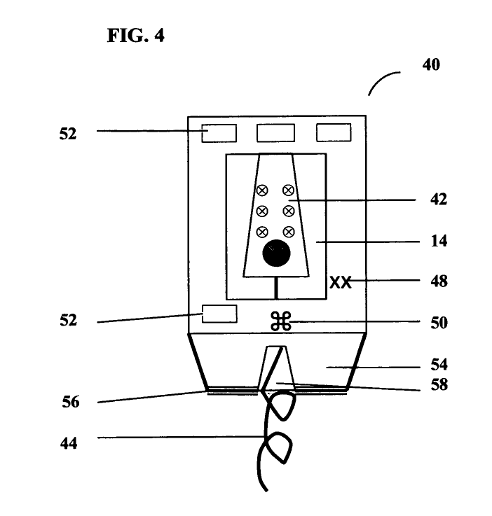

Referring to FIG. 4 the remote control cover 40 is placed over the hospital remote control or nurse call device 42 attached to the cable 44. The transparent window area 14 may be sized to correspond with the buttons on the face of the control. The area surrounding the window may exhibit local cable or channel information 48 or a logo 50 of the establishment. Surrounding the window area, the surface may be imprinted with color to increase visibility of other text 48 or logos 50. In addition, the surrounding surface area of the transparent window may also contain light reflecting rectangular shapes 52 which are displayed in a pattern. For example, a row of rectangular light reflecting shapes indicate the front end of the remote control device, whereas a single rectangular shape identifies the rear end of the control to assist in locating and using the control device in dim lighting. An optional closure tab 54 secures the control device through its adhesive strip 56 or other means of fastening, from the group including releasable adhesives, snaps, Velcro™ or adhesives. An opening 58 in the closure tab 54 facilitates the cable 44 which is connected to the remote control device. A notch opening 58 is depicted in FIG. 4 allows passage of the cable connection and at the same time provides additional security for the control when the closure tab 54 is fastened. The preferred embodiment is to have a cover with no closure tab as in FIG. 1. However, for hospital use, the closure tab provides passage for the cables which are often used in this environment.

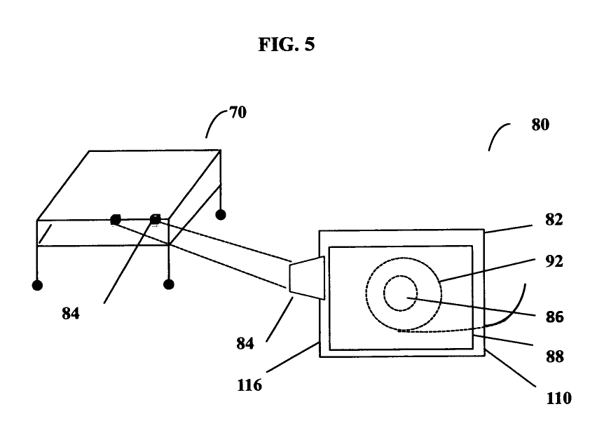

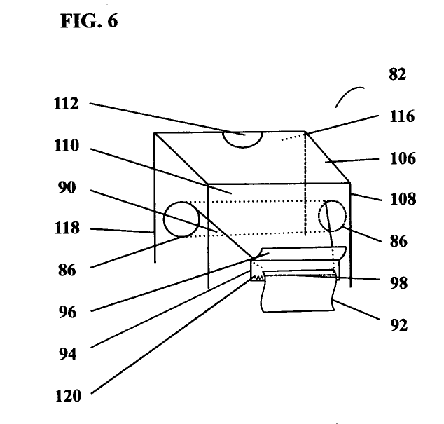

In FIG. 5, a commercial cleaning cart 70 is fit with a dispensing unit 80 consisting of the refillable container 82 lined with polymeric material 88, mounting brackets 84, slit-type opening with flap and fastening device (shown in FIG. 6), and roll holding components 86. The mounting bracket 84 facilitates a means of attachment onto the cart and articulates with the other part of the bracket 84 located on the dispensing unit 80. The bracket 84 may be connected to the container 82 at any location on its sides, however the preferred embodiment is on the rear panel 116, opposite the slit-like opening found in the front panel 110. An alternative embodiment discloses an attachment means by using the roll holding components 86 which articulate with the bracket which attaches to the cart. The refillable container 82 is comprised of material selected from the group including paperboard, cardboard, thermoplastics or other polymeric material. The purpose of the container is to protect the covers in a sanitary manner till they are dispensed, without a need for individual packaging or backing. Because the cleaning cart carries soiled laundry, trash, mops and the like, it is important to hygienically dispense the remote control covers, without creating additional refuse from packaging. The dispensing container 82 is lined with a polymeric material 88 for added protection from contaminants. An alternative location for the dispensing unit 82 is at the front desk of the hotel where the customer receives the cover when checking in. The cover may be placed within the same envelope with the room key.

In FIG. 6, the top part of the dispensing container is shown, revealing 3 pairs of parallel panels: top and bottom (only the top 106 is shown) panels; front panel 110 and rear panel 116; a right side panel 108 and left side panel 118. As the preferred embodiment, the top panel 106 may open by lifting or pressing the release tab 112 which is located at the top of the rear panel 116 resulting in lifting the top panel to facilitate insertion and removal of the roll 90. However, insertion may also be from the back panel 116, side 108 or 118, or front panel 110, relative to where the release tab is placed.

The joining member 90 is positioned on the roll holding components 86. The joining member may be in the shape of a rod which supports the roll of remote control covers. An alternative embodiment is one which integrates the supporting rod with the roll of remote control covers and is fabricated as one unit. In either embodiment, the roll holding components 86 are positioned on the side panels 108 and 118 and are comprised from one the following group containing plastics, metals, cardboard, composites and biodegradable materials. In the preferred embodiment, the biodegradable roll holding components 86 are attached on the inside of the dispensing container by adhesives. In an alternative embodiment openings placed in the side panels 108 and 118 may also be used to support the roll holding components which receive the roll of remote control covers. The roll holding components 86 are shown as circular, however they may also be configured as semi-circular and comprised of a both metal and plastics.

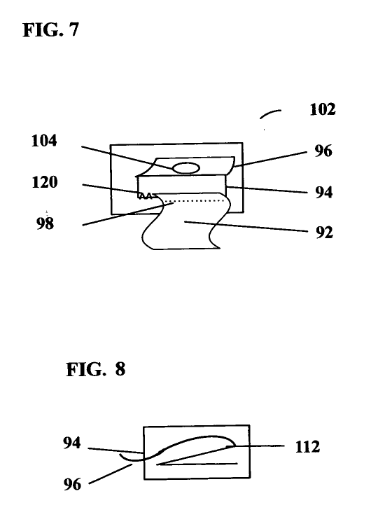

Referring to FIG. 6, this embodiment of the dispensing container 82 shows the joining member 90, which connects the roll holding components 86 to provide support for the roll 92 of covers, which are fastened end to end wrapped around a core. This is also shown in the side-view depicted in FIG. 5. The slit-type opening 94 facilitates dispensing of an individual cover. Above the slit-type opening 94 is a flap 96 (shown in a raised position in FIG. 6) which serves to restrict contaminants from entering the container 82. The flap contacts the covers without restricting movement as the outermost layer of covers will pass through and will be separated at the perforation 98 leaving a small section of the next cover 92 exposed and prepared for dispensing. A serrated component 120 of the dispensing apparatus 102 (shown in FIG. 7) provides a method of separation between covers through perforation and thus removal of one sanitary cover.

In FIG. 7, the blown-up view of the dispensing apparatus 102 reveals the slit-like opening 94 and flap 96 with a fastener 104 attached to or placed on the flap 96. The fasteners may be comprised of snaps, Velcro™, adhesives, magnets, hooks or releasable adhesives to secure the flap covering the dispensing apparatus. Although it is not shown in FIG. 7, when the flap 96 is pulled down and attached to the front panel just below the slit-like opening 94, it will cover the dispensing apparatus 102 including part of the next cover 92, when not in use. The flap 96 provides protection from contaminants in the surrounding environment from entering the container through the slit like opening 94. Because the reusable container is bracketed onto the cleaning cart, the flap 96 protects the contents of the dispensing container from cleaning supplies or trash also carried on the cart. To enable the separation of the roll of covers into individual units 92, the perforation 98 is placed over serrated or peg-like structure 120 and downward pressure is applied. It should be further noted that while the preferred embodiment of the commercial dispensing apparatus as described includes a refillable container and reusable dispensing apparatus as illustrated in FIGS. 5, 6 and 7, said dispensing unit may also be represented in another embodiment as a simple box-like structure with an opening in a side panel with a slit-like passage 94, shown in FIG. 8. The covers inside the box may be folded in accordion style 112 and removed individually by tearing the perforation 114. While specific embodiments of the present invention have been described, it will be apparent to one of ordinary skill in the art that many changes, modifications and improvements can be made without departing from the spirit and scope of this invention.

The invention claimed is:

1. A disposable cover for use with a remote control device comprising:
a top and bottom panel which relate to the shape of the remote control device it is covering;
the top panel containing a window of transparent film;
the top and bottom panels joined on the edges of 3 sides;
material which is flexible and moisture-resistant;
a means for dispensing an individual disposable cover through a reusable dispensing apparatus and refillable dispensing unit which provide hygienic dispensing using minimal space and packaging.

2. The device of claim 1, the means of joining the top and bottom panels are selected from the group of heat welding, ultrasonic bonding, or adhesives.

3. The device of claim 1 having an optional closure tab with a means of fastening when used with a cabled remote control device.

4. The means of fastening on the optional closure tab in claim 3 is selected from the group of releasable adhesives, snaps, Velcro™, and adhesives.

5. The device of claim 1, comprised of biodegradable material.

6. The device of claim 1, comprised of thermoplastic material.

7. The device of claim 1, having light reflective rectangles placed in a pattern on the top panel to indicate the position of the remote control in dim light.

8. The device of claim 1 packaged in booklets, and removed individually through separation at the perforation;

9. The device of claim 1 configured in a roll of individual covers which are connected end to end and placed within a dispensing container; the roll of covers have perforations to allow the separation of individual covers when removed from the dispensing enclosure.

10. The device of claim 1 which are folded in an accordion manner within the dispensing container and separated into individual covers through separation at the perforation when removed from dispensing container.

11. The dispensing container of claim 9 contains a bracket on one panel which joins the bracket located on the cleaning cart, providing stability and support for the dispensing unit.

12. The dispensing container of claim 9 is lined with polymeric material.

13. The dispensing container of claim 9 contains a slit-type opening which is covered with a flap and secured by a closure device;

14. The closure device of claim 13 is comprised of a material selected from the group consisting of snaps, adhesives, magnets, Velcro™, hooks and releasable adhesives.

15. The slit-type opening of claim 13 contains a separating component which facilitates removal of individual covers type as they pass through the dispensing apparatus.

16. The separating component of claim 15 is comprised of a material selected from the group consisting of biodegradable, metal or polymeric materials in a serrated or peg like form.

17. A panel of the dispensing container of claim 9 contains a release tab to facilitate insertion and removal of the roll of disposable covers.
